(19) United States
(12) Patent Application Publication
(10) Pub. No.: US 2015/0051724 A1
(43) Pub. Date: Feb. 19, 2015

(54) COMPUTING DEVICE AND SIMULATION METHOD FOR GENERATING A DOUBLE CONTOUR OF AN OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/459,754

(22) Filed: Aug. 14, 2014

(30) Foreign Application Priority Data
Aug. 14, 2013 (CN) 2013103519468

(51) Int. Cl. G05B 19/19

(52) U.S. Cl. CPC G05B 19/19; G05B 2219/36227
USPC 700/97

(57) ABSTRACT

A computing device processes an object according to a first CNC processing program. The computing device adjusts the first CNC processing program and processes the object according to the adjusted first CNC processing program. The computing device adjusts a second CNC processing program and processes the object according to the adjusted second CNC processing program. The double contour of the object is generated after the object is processed by the computing device according to the adjusted first CNC processing program and the adjusted second CNC processing program.

### CROSS-REFERENCE TO RELATED APPLICATIONS

This application claims priority to Chinese Patent Application No. 201310351946.8 filed on Aug. 14, 2013 in the State Intellectual Property Office of the People's Republic of China, the contents of which are incorporated by reference herein.

### FIELD

Embodiments of the present disclosure relate to a simulation technology, and particularly to a computing device and a simulation method for generating a double contour of an object.

### BACKGROUND

A computerized numerical control (CNC) machine can process an object to produce a double contour. However, a processing tolerance exceeds a predetermined tolerance when the object is processed by the CNC machine.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device.

FIG. 2 illustrates a block diagram of an example embodiment of a double contour generating system in the computing device in FIG. 1.

FIG. 3 shows a plan view of an example of a fixture.

FIG. 4 illustrates an example embodiment of a processing program.

FIG. 5 illustrates an example embodiment of a reference edge consisting of a plurality of points.

FIG. 6 illustrates an example embodiment of a double contour.

FIG. 7 illustrates an example embodiment of an image of the double contour captured by a charge coupled device (CCD).

FIG. 8 illustrates an example embodiment of each first reference point corresponding to a first processing point.

FIG. 9 is a flowchart of an example embodiment of a method for generating a double contour of an object.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

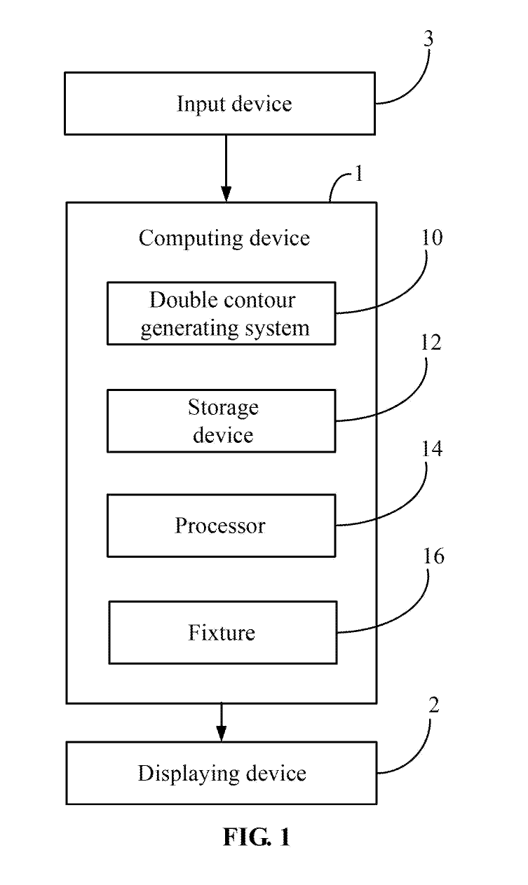

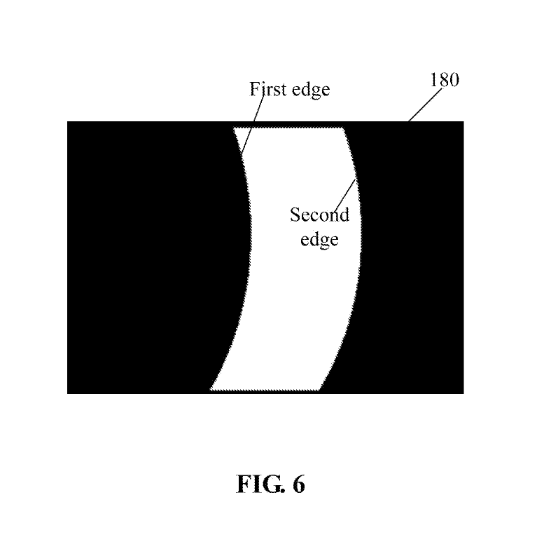

FIG. 1 illustrates a block diagram of an example embodiment of a computing device 1. In the embodiment, the computing device 1 connects to an input device 3 and a displaying device 2. The computing device 1 can be, but is not limited to, a computerized numerical control (CNC) machine or other image measurement machines. In the example embodiment, the computing device 1 includes, but is not limited to, a double contour generating system 10, a storage device 12, at least one processor 14, and a fixture 16. FIG. 1 illustrates only one example of the computing device 1, and other examples can comprise more or fewer components than those shown in the embodiment, or have a different configuration of the various components. The computing device 1 processes an object to acquire a double contour. The double contour includes a first edge and a second edge. The first edge and the second edge are the same shape and are located at different positions of the object. For example, as shown in FIG. 6, the first edge and the second edge are located at different positions of the object. The object can be a component of a product, such a shell of a mobile phone.

In one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1.

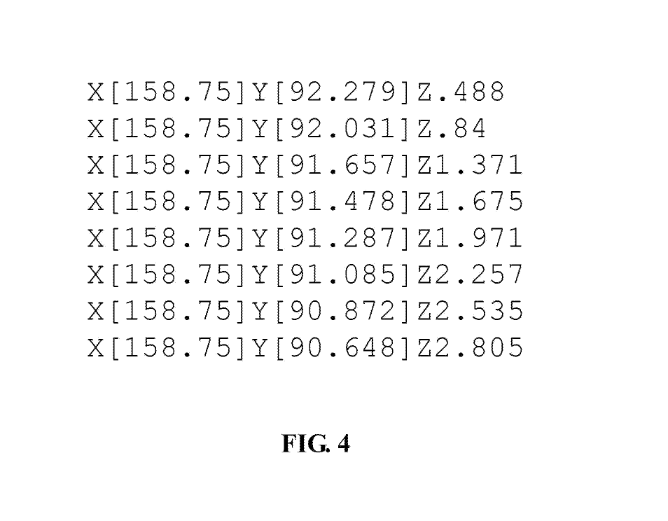

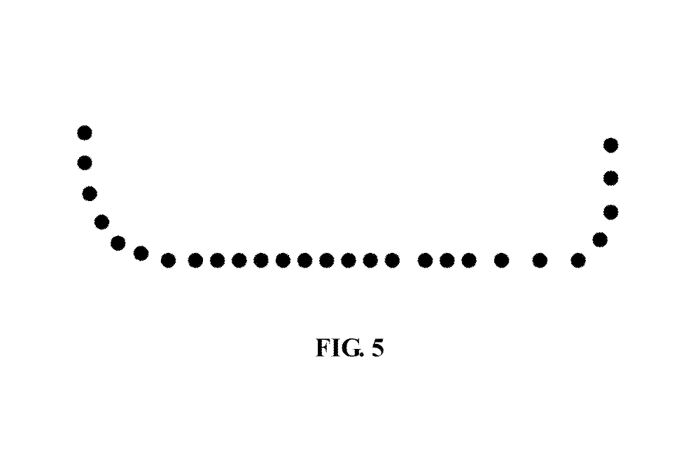

The storage device 12 stores a first CNC processing program and a second CNC processing program. The first CNC processing program is an array program which consists of a plurality of coordinates of first reference points as shown in FIG. 4, where the first reference points are predetermined according to user requirements and used for consisting of the first edge as shown in FIG. 5. The second CNC processing program is an array program which consists of a plurality of coordinates of second reference points, where the second reference points are predetermined by the user and used for consisting of the second edge. In addition, either the first processing program or the second CNC processing program can be, but are not limited to, a TXT format file. Each row of the first processing program or the second CNC processing program includes keywords for coordinates of each first reference point, as shown in FIG. 4, each row in the first CNC processing program includes keywords X, Y, and Z for coordinates of the first reference point. The computing device 1 processes the object to acquire the first edge according to the first CNC processing program. The computing device 1 processes the object to acquire the second edge according to the second CNC processing program.

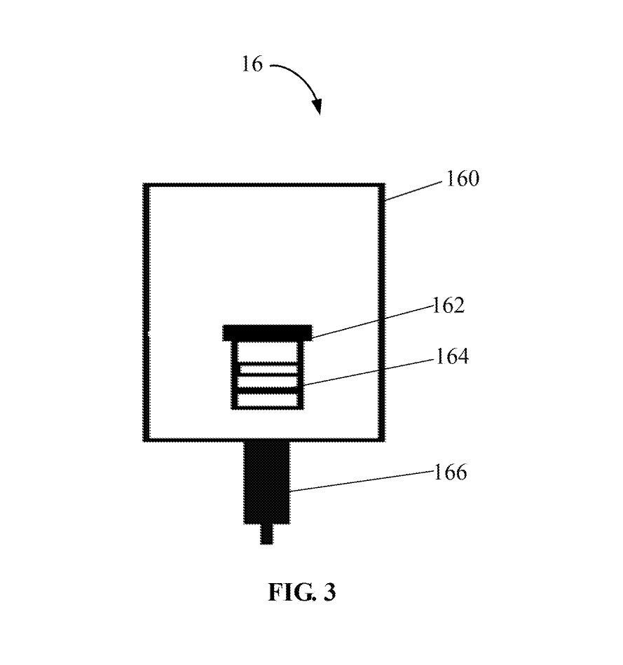

As shown in FIG. 3, the fixture 16 includes a principal axis 160, a charge coupled device (CCD) 162, a lens 164 and a blade 166. The principal axis 160 can be, but is not limited to, a cylinder or a cube. The CCD 162 and the lens 164 are located at the principal axis 160. The blade 166 is located at the bottom of the principal axis 160 and processes an object to obtain a double contour from the object. The lens 162 is located at the top of the principal axis 160 and captures images when the blade 166 processes the object. The principal axis 160 can move at a predetermined area, so that the blade 166 can cut the object at different positions.

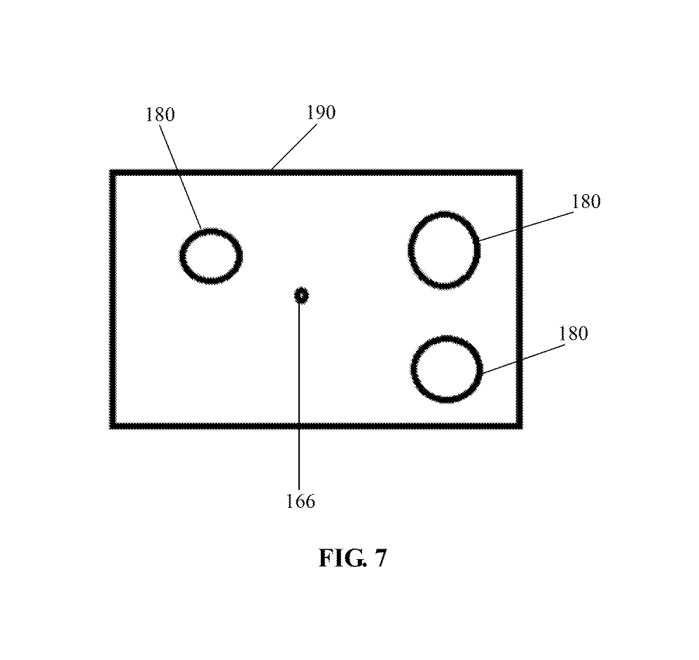

In addition, a vertical axis which is vertical to an image plane of the CCD 162 intersects to a principal axis 160, so that the blade 166 is positioned at a center point of the image plane of the CCD 162. The CCD 162 can capture images of the object while the blade 166 processes the object. As shown in FIG. 7, the image plane 190 of the CCD 162 is captured by the CCD 162, the image plane 190 includes the blade 166 and one or more objects 180, the center point of the image plane 190 superposes on the blade 166, so that the CCD 162 captures images of the object when the blade 166 processes the object 180.

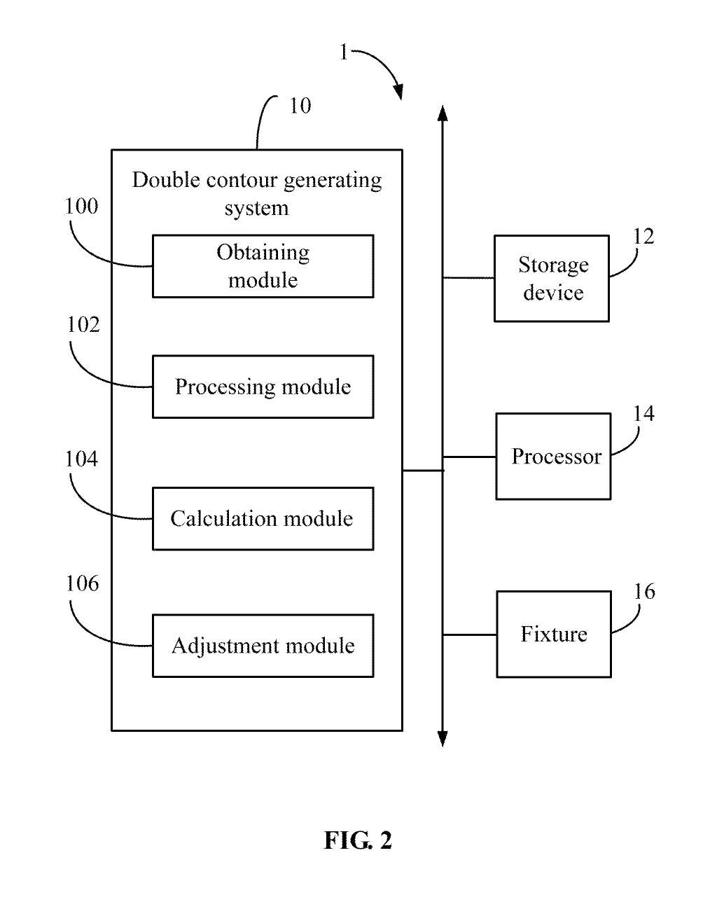

FIG. 2 illustrates a block diagram of an example embodiment of a double contour generating system in the computing device 1. The double contour generating system 10 comprises, but is not limited to, an obtaining module 100, a processing module 102, a calculation module 104, and an adjustment module 106. Modules 100-106 can comprise computerized instructions in the form of one or more computer-readable programs that can be stored in a non-transitory computer-readable medium, for example the storage device 12, and executed by the at least one processor 14 of the computing device 1.

The obtaining module 100 obtains a first CNC processing program from the storage device 12. In addition, the obtaining module 100 further authenticates the first CNC processing program. In one embodiment, if each row of the first CNC processing program includes keywords for coordinates of each first reference point, the first CNC program is authenticated to be correct. Otherwise, if one row of the first CNC processing program does not include the keywords, the first CNC program is authenticated to be incorrect, and an error (for example, a first CNC program is incorrect) is displayed in the displaying device 3.

The processing module 102 processes an object 180 according to the first CNC processing program and acquires coordinates of first processing points. In one embodiment, the processing module 102 moves the blade 166 to coordinates of each first reference point, and processes the object 180 using the blade 166. The processing module 120 captures an image of the object when the blade 166 processes the object 180 at a position of the coordinates of each first reference point. The processing module 120 obtains two dimensional coordinates of each first processing point from the image of the object 180, two dimensional coordinates of each first processing point include a X-axis value and a Y-axis value, then the processing module 120 obtains a Z-axis value of the image of the object 180 from a linear scale of the computing device 1 when the CCD 120 captures the image of the object 180. The coordinates of each first processing point consists of the two dimensional coordinates of the first processing point and the Z-axis value of the image of the object 180.

The calculation module 104 establishes a relationship between each first reference point and one first processing point. In one embodiment, the relationship between each the first reference point and one first processing point is established by: the calculation module 104 calculates distances between one of the first reference points and all of the first processing points. The calculation module 104 determines a minimum distance among the calculated distances, determines a first processing point corresponding to the minimum distance, and establishes the relationship between the first reference point and the determined first processing point.

The calculation module 104 calculates a first deviation value between each first reference point and an established first processing point and adjusts the first CNC processing program according to the first deviation value. The first deviation value is a distance between each first reference point and an established first processing point. In one embodiment, the first deviation value includes the X-axis value, the Y-axis value and the Z-axis value. The calculation module 104 adjusts coordinates of each the first reference point in the first CNC processing program according to the first deviation value, and acquires an adjusted first CNC processing program. In addition, the first deviation value can be rounded to three decimal places when the deviation value is used to adjust coordinates of the first reference point.

The processing module 102 further processes the object 180 according to the adjusted first CNC processing program and acquires coordinates of second processing points.

The adjustment module 106 calculates a second deviation value corresponding to each second reference point in the a second CNC processing program according to the second processing points. In one embodiment, the second deviation value includes the X-axis value, the Y-axis value and the Z-axis value. The second deviation value is calculated as follow: D=d1−d2, where D is the second deviation value corresponding to each second reference point, d1 is a minimum distance from the second reference point to one second processing point, and d2 is a distance between the first edge and the second edge.

The adjustment module 106 further adjusts the second CNC processing program according to the second deviation value. In one embodiment, the adjustment module 106 adjusts coordinates of each the second reference point in the second CNC processing program according to the second deviation value, and acquires an adjusted second CNC processing program. In the embodiment, the object 180 is processed according to the adjusted CNC processing program to generate the double contour of the object 180.

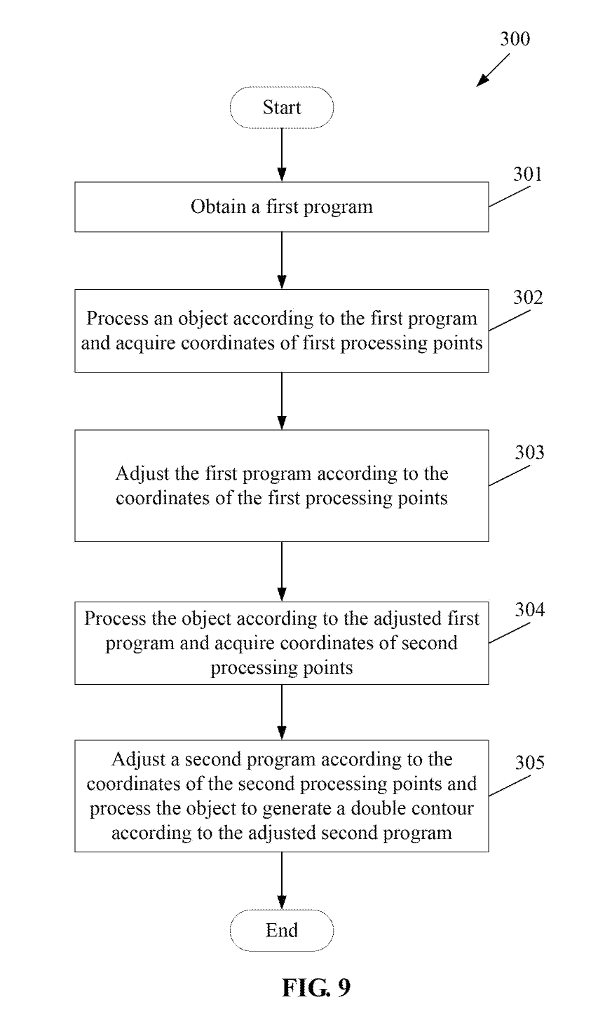

FIG. 9 is a flowchart of an example embodiment of a method for generating a double contour of an object. In an example embodiment, the method is performed by execution of computer-readable software program codes or instructions by at least one processor 14 of a computing device 1, and can automatically processes the object 180.

Referring to FIG. 9, a flowchart is presented in accordance with an example embodiment. The method 300 is provided by way of example, as there are a variety of ways to carry out the method. The method 300 described below can be carried out using the configurations illustrated in FIGS. 1 and 9, for example, and various elements of these figures are referenced in explaining example method 300. Each block shown in FIG. 9 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

In block 301, an obtaining module obtains a first CNC processing program from the storage device.

In block 302, a processing module processes an object according to the first CNC processing program and acquires coordinates of first processing points. In one embodiment, the processing module moves the blade to coordinates of each first reference point, and processes the object using the blade. The coordinates of each first processing point are obtained from an image of the object when the blade processes the object at a position of the coordinates of each first reference point. In detail, the processing module obtains an X-axis value and a Y-axis value of the first processing point from the image of the object and a Z-axis value of the image of the object from a linear scale of the computing device when the CCD captures the image of the object.

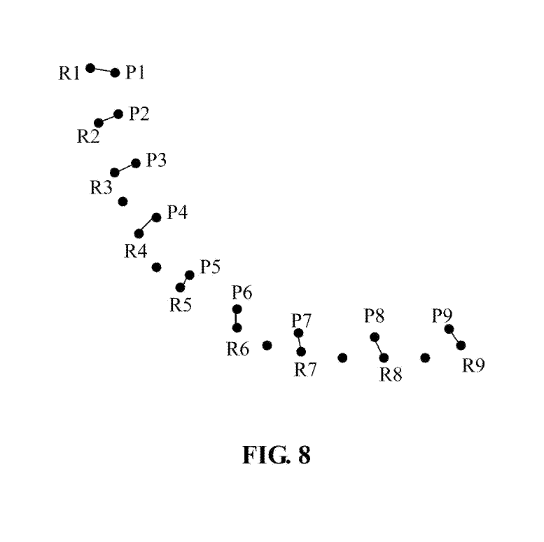

In block 303, a calculation module establishes a relationship between each first reference point and one first processing point, calculates a first deviation value between each first reference point and an established first processing point, and adjusts the first CNC processing program according to the first deviation value. As shown in FIG. 8, the first reference point P1 is related to the first processing point R1. In addition, the calculation module 104 eliminates the first processing points which have no relationship with any first reference points. The first deviation value is a distance between each first reference point and an established first processing point.

In block 304, the processing module processes the object according to the adjusted first CNC processing program and acquires coordinates of second processing points.

In block 305, an adjustment module calculates a second deviation value corresponding to each second reference point in the a second CNC processing program according to the second processing points, and adjusts the second CNC processing program according to the second deviation value. The computing device processes the object according to the adjusted CNC processing program and acquires the double contour of the object. The object is changed to be the double contour after the object is processed by the blade according to the adjusted first CNC processing program and the adjusted second CNC processing program.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores a first computerized numerical control (CNC) processing program and a second CNC processing program, which when executed by the at least one processor, cause the at least one processor to:
process an object according to the first CNC processing program and acquire coordinates of first processing points;
access first reference points from the first CNC processing program and establish a relationship between each first reference point in the first CNC processing program and a first processing point;
calculate a first deviation value between each first reference point and an established first processing point;
adjust the first CNC processing program according to the first deviation value;
process the object according to the adjusted first CNC processing program and acquire coordinates of second processing points;
access second reference points from the second CNC processing program and calculate a second deviation value corresponding to each second reference point in the second CNC processing program according to the second processing points;
adjust the second CNC processing program according to the second deviation value; and
process the object according to the adjusted CNC processing program and acquire a double contour of the object.

2. The computing device of claim 1, wherein the first CNC processing program is an array program which consists of a plurality of coordinates of first reference points, and the second CNC processing program is an array program which consists of a plurality of coordinates of second reference points.

3. The computing device of claim 1, wherein the relationship between each the first reference point and the first processing point is established by:
calculating distances between one of the first reference points and all of the first processing points;
determining a minimum distance among the calculated distances;
determining the first processing point corresponding to the minimum distance; and
establishing the relationship between the first reference point and the determined first processing point.

4. The computing device of claim 1, wherein the first deviation value is a distance between each first reference point and the established first processing point.

5. The computing device of claim 1, wherein the second deviation value is calculated by a formula as follow: D=d1−d2, where D is the second deviation value corresponding to each second reference point, d1 is a minimum distance from the second reference point to one second processing point, and d2 is a distance between a first edge of the double contour and a second edge of the double contour.

6. The computing device of claim 1, wherein the computing device captures an image of the object when the computing device processes the object at a position of the coordinates of each first reference point.

7. The computing device of claim 6, wherein the coordinates of each first processing point are obtained from the image of the object when the computing device processes the object at the position of the coordinates of each first reference point.

8. The computing device of claim 1, wherein the computing device captures an image of the object when the computing device processes the object at a position of the coordinates of each adjusted first reference point.

9. The computing device of claim 8, wherein the coordinates of each second processing point are obtained from the image of the object when the computing device processes the object at the position of the coordinates of each adjusted first reference point.

10. A method for generating a double contour of an object using a computing device, the simulation method comprising:
processing the object according to a first computerized numerical control (CNC) processing program stored in a storage device of the computing device and acquire coordinates of first processing points;
access first reference points from the first CNC processing program and establishing a relationship between each first reference point in the first CNC processing program and a first processing point and calculating a first deviation value between each first reference point and an established first processing point;
adjusting the first CNC processing program according to the first deviation value;
processing the object according to the adjusted first CNC processing program and acquiring coordinates of second processing points;
access second reference points from the second CNC processing program and calculating a second deviation value corresponding to each second reference point in a second CNC processing program stored in a storage device of the computing device according to the second processing points;
adjusting the second CNC processing program according to the second deviation value; and
processing the object according to the adjusted CNC processing program and acquires the double contour of the object.

11. The simulation method of claim 10, wherein the first CNC processing program is an array program which consists of a plurality of coordinates of first reference points, and the second CNC processing program is an array program which consists of a plurality of coordinates of second reference points.

12. The method of claim 10, wherein the relationship between each the first reference point and the first processing point is established by:
calculating distances between one of the first reference points and all of the first processing points;
determining a minimum distance among the calculated distances;
determining the first processing point corresponding to the minimum distance; and
establishing the relationship between the first reference point and the determined first processing point.

13. The method of claim 10, wherein the first deviation value is a distance between each first reference point and the established first processing point.

14. The method of claim 10, wherein the second deviation value is calculated as follow: D=d1−d2, where D is the second deviation value corresponding to each second reference point, d1 is a minimum distance from the second reference point to one second processing point, and d2 is a distance between a first edge of the double contour and a second edge of the double contour.

15. The method of claim 10, wherein the computing device captures an image of the object when the computing device processes the object at a position of the coordinates of each first reference point.

16. The method of claim 15, wherein the coordinates of each first processing point are obtained from the image of the object when the computing device processes the object at the position of the coordinates of each first reference point.

17. The method of claim 10, wherein the computing device captures an image of the object when the computing device processes the object at a position of the coordinates of each adjusted first reference point.

18. The method of claim 17, wherein the coordinates of each second processing point are obtained from the image of the object when the computing device processes the object at the position of the coordinates of each adjusted first reference point.
